(19) United States
(12) Patent Application Publication
(10) Pub. No.: US 2006/0169333 A1
(43) Pub. Date: Aug. 3, 2006

(54) Combination excess-flow/back-flow valve

(75) Inventor: Edward R. Lee SR., Martindale, TX (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: S.H. Leggitt Company

(21) Appl. No.: 11/338,490

(22) Filed: Jan. 23, 2006

Related U.S. Application Data
(60) Provisional application No. 60/648,506, filed on Jan. 31, 2005.

(51) Int. Cl. F16K 15/04

(52) U.S. Cl. 137/539

(57) ABSTRACT

A combination valve includes a valve body having a valve body passageway with an inlet and an outlet opposite the inlet. An excess-flow seat is positioned within the valve body passageway approximate the outlet. A back-flow seat is positioned within the valve body passageway approximate the inlet. The valve includes a slug positioned within the valve body passageway, between the excess-flow and back-flow seats. A spring is positioned within the valve body passageway to bias the slug away from the excess-flow seat toward the back-flow seat. The excess-flow seat includes a bypass passageway that allows a predetermined amount of flow, when the slug is seated in the excess-flow seat. The slug prevents back-flow when the slug is seated in the back-flow seat.

### CROSS-REFERENCE TO RELATED APPLICATION

This application claims priority to Provisional Patent Application Ser. No. 60/648,506, filed Jan. 31, 2005, entitled COMBINATION EXCESS-FLOW/BACK-FLOW VALVE.

### BACKGROUND OF THE INVENTION

The present invention is generally directed to a valve and, more specifically, to a combination excess-flow/back-flow valve.

Traditionally, valves have been utilized in various piping systems to control the flow of liquids or gases. For example, some piping systems have incorporated excess-flow valves, as a safety feature, to limit the flow of fluids or gases into downstream portions of the system. Other piping systems have incorporated back-flow valves to prevent fluids or gases from flowing back toward a fluid or gas source. Various other piping systems have incorporated both excess-flow and back-flow valves. In at least one piping system, an automatic changeover regulator device has been connected to two Department of Transportation (DOT) liquid propane (LP) gas cylinders. The automatic changeover regulator has allowed a user to select one of the cylinders as a service cylinder and the other cylinder as a reserve or stand-by cylinder.

In this system, when the gas supply in the service cylinder was depleted, the reserve cylinder continued to supply gas to the system. Upon detecting that the service cylinder was depleted, a user of the system would then actuate the cylinder selector on the regulator device to select the reserve cylinder, making it the current service cylinder. In this manner, the empty, former service cylinder could be disconnected for refilling. Back-flow valves have also been implemented within piping systems, which have included an automatic changeover regulator device, to prevent gas in a line of the piping system from being discharged into the atmosphere when a gas source is disconnected from the system. Excess-flow valves have also been implemented within piping systems, which have included an automatic changeover regulator device, to provide a bypass flow that slowly charges a part of the system that is downstream of the excess-flow valve. In such systems, when there is a leak in the system downstream of the excess-flow valve, or the demand exceeds the bypass flow rate, downstream pressure does not build-up and the excess-flow valve remains in a closed position.

In general, excess-flow valves have included an excess-flow seat that has a built-in precision flaw or passageway that allows flow to bypass the excess-flow seat to allow a predetermined amount of the flow around the seat, when the excess-flow valve is in the closed position. In most applications, an excess-flow valve will activate each time the pressure source valve is opened, to introduce flow, due to the flow surge into the empty system. It should be appreciated that if the excess-flow valve were to shut off flow completely, then pressure would never develop downstream of the excess-flow valve and the excess-flow valve would fail to re-open. Today, known piping systems that implement automatic changeover regulators utilize two separate valves to provide excess-flow and back-flow functions. In general, a piping system that implements multiple valves to perform excess-flow and back-flow functions is more costly to install and maintain.

What is needed is a combination valve that economically performs both excess-flow and back-flow functions for a piping system.

### SUMMARY OF THE INVENTION

According to one embodiment of the invention, a combination valve includes a valve body having a valve body passageway that includes an inlet and an outlet, opposite the inlet.

An excess-flow seat is positioned within the valve body passageway approximate the outlet. A back-flow seat is positioned within the valve body passageway approximate the inlet. The valve includes a slug positioned within the valve body passageway between the excess-flow and back-flow seats. A spring is positioned within the valve body passageway to bias the slug away from the excess-flow seat toward the back-flow seat. The excess-flow seat includes a bypass passageway that allows a predetermined amount of flow, when the slug is seated in the excess-flow seat. The slug prevents back-flow when the slug is seated in the back-flow seat.

According to another aspect of the present invention, the valve body passageway is centrally located with respect to the valve body. According to another aspect of the present invention, the back-flow seat is provided by an 0-ring and a portion of a guide pin, both of which are positioned within the valve body passageway.

These and other features, advantages and objects of the present invention will be further understood and appreciated by those skilled in the art by reference to the following specification, claims and appended drawings.

### BRIEF DESCRIPTION OF THE DRAWINGS

FIG. 1A is an inlet view of an exemplary combination valve, constructed according to one embodiment of the present invention;

FIG. 1B is a side view of the combination valve of FIG. 1A;

FIG. 1C is a cross-sectional view, along the line 1C-1C, of the combination valve of FIG. 1B;

FIG. 2A is a side view of a valve body, which is a component of the combination valve of FIG. 1A;

FIG. 2B is an outlet view of the valve body of FIG. 2A;

FIG. 2C is a cross-sectional view of the valve body of FIG. 2B, along the line 2C-2C;

FIG. 2D is an exploded view of the area 2D of FIG. 2C;

FIG. 2E is an exploded view of the area 2E of FIG. 2C;

FIG. 2F is an expanded view of the area 2F of FIG. 2A;

FIG. 3A is a side view of a guide pin, which is a component of the combination valve of FIG. 1A;

FIG. 3B is an inlet view of the guide pin of FIG. 3A;

FIG. 3C is a cross-sectional view of the guide pin of FIG. 3B, along the line 3C-3C;

FIG. 4A is a partial cross-sectional view of the combination valve of FIG. 1A, with the slug in an excess-flow position; and

FIG. 4B is a partial cross-sectional view of the combination valve of FIG. 1A, with the slug in a back-flow position.

### DETAILED DESCRIPTION OF PREFERRED EMBODIMENTS

According to various embodiments of the present invention, a combination valve is disclosed that includes both an excess-flow seat and a back-flow seat. The combination valve is particularly useful when implemented in conjunction with an liquid propane (LP) gas system, such as those that are utilized in the recreational vehicle (RV) market. However, the device may also be used in other applications in which LP gas systems are implemented, such as in small residences and hunting or vacation cabins. Furthermore, it is contemplated that the combination valve may be suitable for other types of piping systems, e.g., fluid and other gas systems. According to the present invention, the combination valve acts as both an excess-flow check valve and a back-flow check valve utilizing a single check feature, such as a slug or a ball, to perform both functions. It is also contemplated that the materials used for the components of the combination valve will vary, depending upon the type of fluid/gas that the valve controls.

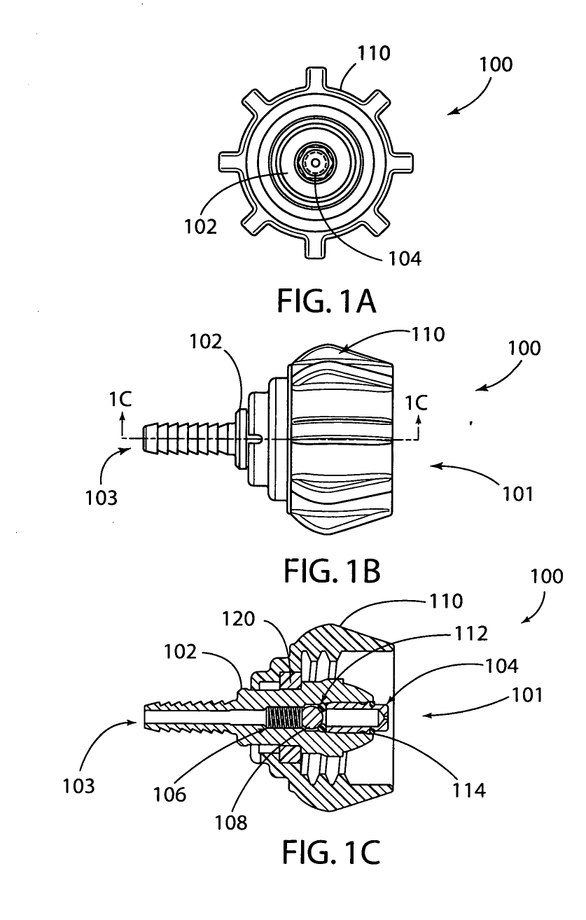

With reference to FIGS. 1A-1C, a combination valve 100 constructed according to one embodiment of the present invention is further illustrated. With specific reference to FIG. 1B, a valve body 102, e.g., made of brass, includes a central passageway having an outlet 103 and an inlet 101. With specific reference to FIG. 1C, a nut 110, e.g., made of nylon, is shown positioned on the valve body 102 and a washer 120, e.g., made of high density polyethylene (HDPE), is positioned on the valve body 102 between a portion of the nut 110 (which allows the valve 100 to be securely connected to a gas or fluid source) and the valve body 102. A spring 106, e.g., made of stainless steel, is positioned with the passageway of the valve body 102, approximate the outlet 103 of the valve body 102. As is shown, a slug 108, e.g., a stainless steel ball, is positioned between the spring 106 and an O-ring 112, e.g., made of rubber, that provides a back-flow seat in conjunction with a guide pin 104, e.g., made of brass, which is retained within the central passageway of the valve body 102 by a retainer 114.

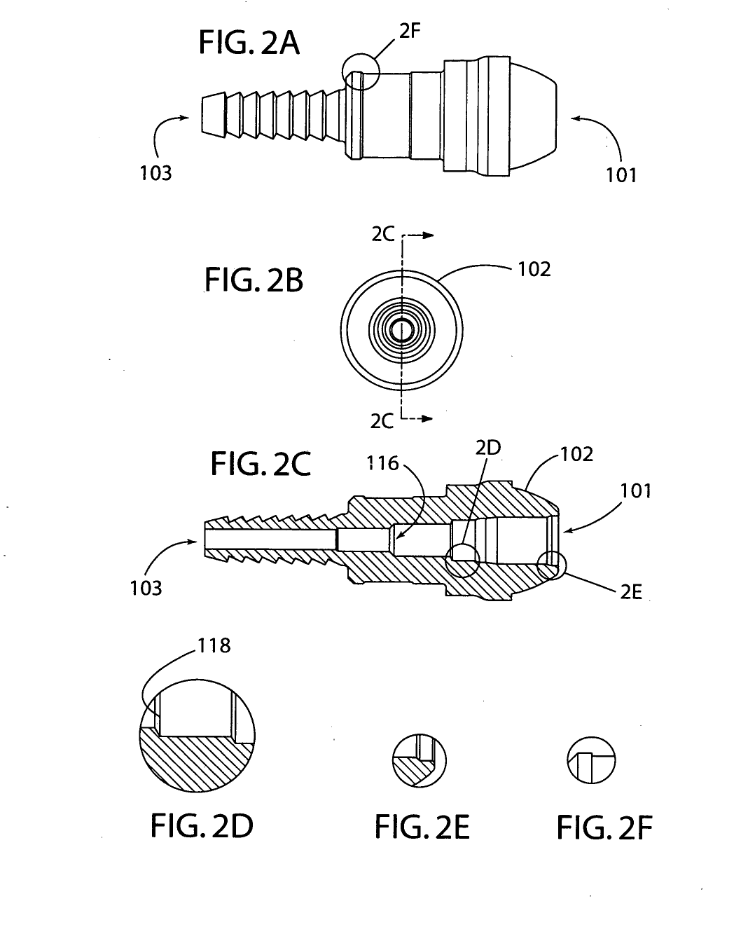

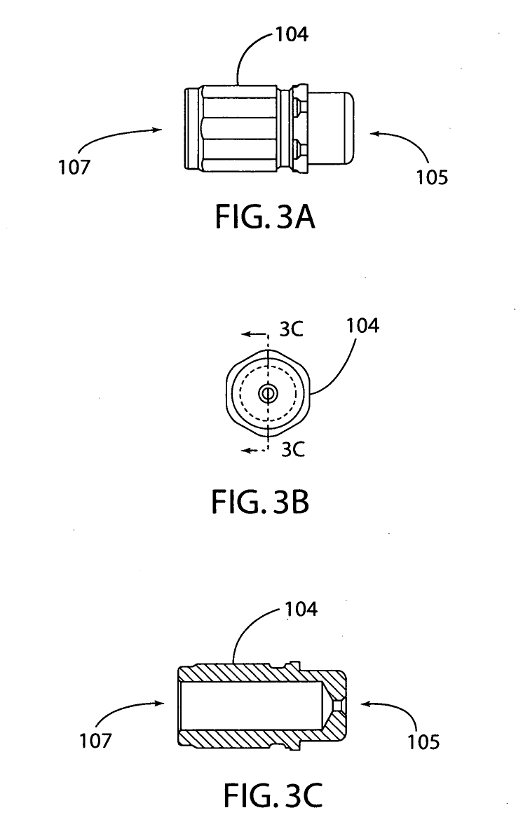

Various features of the valve body 102 are further depicted in FIGS. 2A-2F. With reference to FIG. 2C, an excess-flow seat 116 is integrated within the central passageway of the valve body 102. With reference to FIG. 2D, a bypass passageway 118 is provided to allow a desired flow past slug 108, when the slug 108 is in contact with the seat 116. As is depicted in FIGS. 3A-3C, the guide pin 104 includes a central passageway having an inlet 105 and an outlet 107.

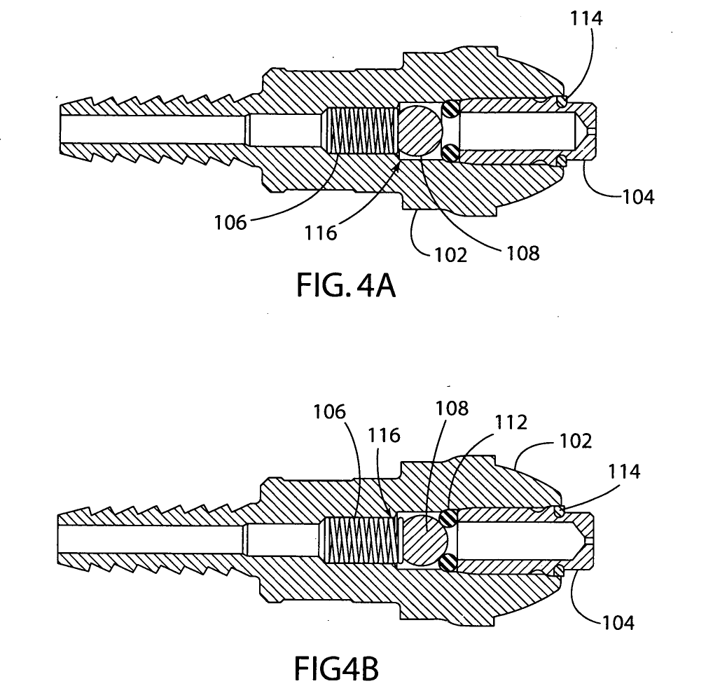

Turning to FIG. 4A, a cross-sectional view of the valve guide body 102 is depicted, which shows the slug 108 in the excess-flow position, i.e., the slug 108 is in contact with the excess-flow seat 116. With reference to FIG. 4B, a cross-sectional view of the valve body 102 depicts the slug 108 in a back-flow position, i.e., the slug 108 is against the O-ring 112, which, in combination with the guide pin 104, provides a back-flow seat. The design of a combination valve, according to the present invention, may take various forms, depending upon the application, and have various dimensions. The selection of the dimensions for the combination valve is considered well within the capability of one of ordinary skill in the art, upon review of this disclosure.

Accordingly, a combination valve has been disclosed herein, which acts as both an excess-flow valve and a back-flow valve. Such a combination valve may be utilized in a variety of different applications and may be particularly advantageously implemented within LP gas piping systems.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A combination valve, comprising:
a valve body including a valve body passageway having an inlet and an outlet opposite the inlet;
an excess-flow seat positioned within the valve body passageway approximate the outlet;
a back-flow seat positioned within the valve body passageway approximate the inlet;
a slug positioned within the valve body passageway between the excess-flow and back-flow seats; and
a spring positioned within the valve body passageway, the spring biasing the slug away from the excess-flow seat toward the back-flow seat, wherein the excess-flow seat includes a bypass passageway that allows a predetermined amount of flow when the slug is seated in the excess-flow seat, and wherein the slug prevents back-flow when the slug is seated in the back-flow seat.

2. The valve of claim 1, wherein the valve body passageway is centrally located with respect to the valve body.

3. The valve of claim 1, wherein the slug is a stainless steel ball.

4. The valve of claim 1, wherein the spring is made of stainless steel.

5. The valve of claim 1, wherein the valve body is made of brass.

6. The valve of claim 1, wherein the back-flow seat is provided by the combination of an O-ring and a portion of a guide pin both of which are positioned within the valve body passageway approximate the inlet, and wherein the guide pin includes a central passageway.

7. The valve of claim 6, wherein the guide pin is made of brass.

8. A combination valve, comprising:
a valve body including a valve body passageway having an inlet and an outlet opposite the inlet;
an excess-flow seat positioned within the valve body passageway approximate the outlet;
a back-flow seat positioned within the valve body passageway approximate the inlet;
a slug positioned within the valve body passageway between the excess-flow and back- flow seats; and
a spring positioned within the valve body passageway, the spring biasing the slug away from the excess-flow seat toward the back-flow seat, wherein the excess-flow seat includes a bypass passageway that allows a predetermined amount of flow when the slug is seated in the excess-flow seat, and wherein the slug prevents back-flow when the slug is seated in the back-flow seat, where the back-flow seat is provided by the combination of an O-ring and a portion of a guide pin, both of which are positioned within the valve body passageway approximate the inlet, and where the guide pin includes a central passageway.

9. The valve of claim 8, wherein the valve body passageway is centrally located with respect to the valve body.

10. The valve of claim 8, wherein the slug is a stainless steel ball.

11. The valve of claim 8, wherein the spring is made of stainless steel.

12. The valve of claim 8, wherein the valve body is made of brass.

13. The valve of claim 12, wherein the guide pin is made of brass.

14. A combination valve, comprising:
a valve body including a valve body passageway having an inlet and an outlet opposite the inlet;
an excess-flow seat positioned within the valve body passageway approximate the outlet;
a back-flow seat positioned within the valve body passageway approximate the inlet;
a slug positioned within the valve body passageway between the excess-flow and back- flow seats; and
a spring positioned within the valve body passageway, the spring biasing the slug away from the excess-flow seat toward the back-flow seat, wherein the excess-flow seat includes a bypass passageway that allows a predetermined amount of flow when the slug is seated in the excess-flow seat, and wherein the slug prevents back-flow when the slug is seated in the back- flow seat, where the valve body passageway is centrally located with respect to the valve body.

15. The valve of claim 14, wherein the slug is a stainless steel ball.

16. The valve of claim 15, wherein the spring is made of stainless steel.

17. The valve of claim 16, wherein the valve body is made of brass.

18. The valve of claim 14, wherein the back-flow seat is provided by the combination of an O-ring and a portion of a guide pin, both of which are positioned within the valve body passageway approximate the inlet, and wherein the guide pin includes a central passageway.

19. The valve of claim 18, wherein the guide pin is made of brass.
